(19) United States
(12) Patent Application Publication
(10) Pub. No.: US 2012/0312011 A1
(43) Pub. Date: Dec. 13, 2012

(54) TURBINE HOUSING AND METHOD FOR DIRECTING EXHAUST

(75) Inventor: Edward R. Romblom, De Witt, MI (US)

(73) Assignee: GM GLOBAL TECHNOLOGY OPERATIONS LLC, Detroit, MI (US)

(21) Appl. No.: 13/157,650

(22) Filed: Jun. 10, 2011

(51) Int. Cl. F02B 37/00; F01N 3/10

(52) U.S. Cl. 60/605.1

(57) ABSTRACT

In one exemplary embodiment of the invention, a turbine housing for a forced induction system of an internal combustion engine is provided, the turbine housing including a turbine inlet passage in fluid communication with a turbine volute configured to house a turbine wheel, the turbine inlet passage configured to direct an exhaust gas flow from an exhaust manifold to the turbine wheel. The housing also includes a turbine outlet passage in fluid communication with the turbine volute, the turbine outlet passage configured to direct the exhaust gas flow to a catalytic converter coupled to the turbine outlet passage, wherein the turbine outlet passage comprises a cone shaped passage.

### FIELD OF THE INVENTION

Exemplary embodiments of the invention are related to forced air induction systems, and more particularly, to a turbine housing for a turbocharger

### BACKGROUND

The use of forced-induction, including turbochargers, in modern internal combustion engines, including both gasoline and diesel engines, is frequently employed to increase the engine intake mass airflow and the power output of the engine. Further, manufacturers of internal combustion engines are presented with the challenging task of complying with emission standards for the release of nitrogen oxides, particularly nitrogen monoxide, as well as unburned and partially oxidized hydrocarbons, carbon monoxide, particulate matter, and other pollutants. In order to reduce the pollutant emissions of an engine, an exhaust gas after treatment system is used to reduce pollutants within the exhaust gas flowing from the engine.

In addition, turbochargers are powered by exhaust gas, so the efficient communication of exhaust between the engine, turbocharger and exhaust after treatment systems necessitates synergistic design of these systems. As engines become more complex, the packaging of various components can make design of the turbocharger challenging. For example, as emissions regulations become more stringent and packaging constraints increase, a closely coupled catalytic converter may be mounted directly to the turbocharger exhaust outlet. This may impact the performance of the turbocharger and/or exhaust after treatment systems. In addition improved packaging and design of the turbocharger and after treatment systems may reduce complexity and number of components, thereby leading to improved cost, efficiency and performance.

### SUMMARY OF THE INVENTION

In one exemplary embodiment of the invention, a turbine housing for a forced induction system of an internal combustion engine is provided, the turbine housing including a turbine inlet passage in fluid communication with a turbine volute configured to house a turbine wheel, the turbine inlet passage configured to direct an exhaust gas flow from an exhaust manifold to the turbine wheel. The housing also includes a turbine outlet passage in fluid communication with the turbine volute, the turbine outlet passage configured to direct the exhaust gas flow to a catalytic converter coupled to the turbine outlet passage, wherein the turbine outlet passage comprises a cone shaped passage.

In another exemplary embodiment of the invention, a method for method for directing exhaust in a forced induction system of an internal combustion engine is provided, wherein the method includes directing an exhaust gas flow from an exhaust manifold via a turbine inlet passage to a turbine volute configured to house a turbine wheel and directing the exhaust gas flow from the turbine volute to a turbine outlet passage, wherein the turbine outlet passage comprises a cone shaped substantially asymmetrical passage. The method also includes directing the exhaust gas flow from the turbine outlet passage to a catalytic converter coupled to the turbine outlet passage.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is an exemplary diagram of an internal combustion engine that includes a turbocharger;

FIG. 2 is a side view of an exemplary turbocharger;

FIG. 3 is a sectional side view of an exemplary turbine portion of the turbocharger of FIG. 2; and

FIG. 4 is a detailed sectional side view of a portion of an exemplary turbine portion.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

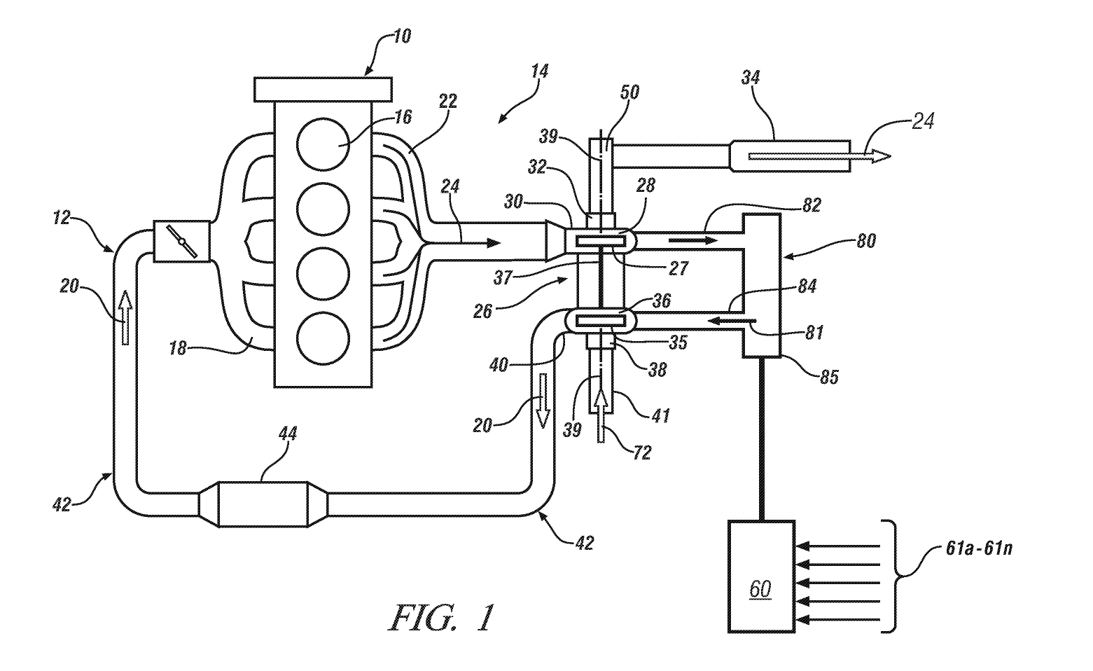

In accordance with an exemplary embodiment of the invention, FIG. 1 illustrates an internal combustion engine 10, in this case an in-line four cylinder engine, including an intake system 12 and an exhaust system 14. The internal combustion engine 10 includes a plurality of cylinders 16 into which a combination of combustion air and fuel are introduced. The combustion air/fuel mixture is combusted in the cylinders 16 resulting in reciprocation of pistons (not shown) therein. The reciprocation of the pistons rotates a crankshaft (not shown) to deliver motive power to a vehicle powertrain (not shown) or to a generator or other stationary recipient of such power (not shown) in the case of a stationary application of the internal combustion engine 10.

The internal combustion engine 10 includes an intake manifold 18 in fluid communication with the cylinders 16; where the intake manifold 18 receives a compressed intake charge 20 from the intake system 12 and delivers the charge to the plurality of cylinders 16. The exhaust system 14 includes an exhaust manifold 22, also in fluid communication with the cylinders 16, which is configured to remove combusted constituents of the combustion air and fuel (i.e. exhaust gas 24) and to deliver it to an exhaust driven turbocharger 26 located in fluid communication therewith. The turbocharger 26 includes an exhaust gas turbine wheel 27 that is housed within a turbine housing 28. The turbine housing 28 includes an inlet 30 and an outlet 32. The outlet 32 is in fluid communication with the remainder of the exhaust system 14 and delivers the exhaust gas 24 to an exhaust gas conduit 34. The exhaust gas conduit 34 may include various exhaust after treatment devices, such as a catalytic converter 50. As depicted, the catalytic converter 50 is close coupled to the outlet 32 of the turbocharger 26 and is configured to treat various regulated constituents of the exhaust gas 24 prior to its release to the atmosphere. In embodiments, the turbocharger 26 may be any suitable forced air induction apparatus, such as a twin scroll turbocharger, twin turbocharger or a supercharger.

The turbocharger 26 also includes an intake charge compressor wheel 35 that is housed within a compressor housing 36. The compressor wheel 35 is coupled by a shaft 37 to the turbine wheel 27, allowing the compressor wheel 35, the shaft 37, and the turbine wheel 27 to rotate about an axis 39. The compressor housing 36 includes an inlet 38 and an outlet 40. The inlet 38 is a passage that is in fluid communication with an air supply conduit 41, which delivers fresh air 72 to the compressor housing 36. The outlet 40 is in fluid communication with the intake system 12 and delivers the compressed intake charge 20 through an intake charge conduit 42 to the intake manifold 18. The intake charge 20 is distributed by the intake manifold 18 to the cylinders 16 of the internal combustion engine 10 for mixing with fuel and for combustion therein. In an exemplary embodiment, disposed inline between the compressor housing outlet 40 and the intake manifold 18 is a compressed intake charge cooler 44. The compressed intake charge cooler 44 receives the heated (due to compression) compressed intake charge 20 from the intake charge conduit 42 and, following cooling of the compressed intake charge 20 therein, delivers it to the intake manifold 18 through a subsequent portion of the intake charge conduit 42.

Located in fluid communication with the exhaust system 14, and in the exemplary embodiment shown in FIG. 1, is an exhaust gas recirculation (“EGR”) system 80. The EGR system 80 includes EGR supply conduit 82, EGR inlet conduit 84, and EGR valve 85. In one embodiment, the EGR supply conduit 82 is in fluid communication with and coupled to turbine housing 28. In addition, the EGR inlet conduit 84 is in fluid communication with and coupled to compressor housing 36. The EGR supply conduit 82 is configured to divert a portion of the exhaust gas 24 from the turbine housing 28 and to recirculate it to the intake system 12 through the compressor housing 36 of the exhaust driven turbocharger 26. As depicted, the EGR valve 85 is in signal communication with a control module such as an engine controller 60. The EGR valve 85 adjusts the volumetric quantity of received exhaust gas 24 that is diverted, as recirculated exhaust gas 81 (“EGR”), to the intake system 12, based on the particular engine operating conditions at any given time. The engine controller 60 collects information regarding the operation of the internal combustion engine 10 from sensors 61a-61n, such as temperature (intake system, exhaust system, engine coolant, ambient, etc.), pressure, exhaust system conditions, driver demand and, as a result, may adjust many engine conditions and operations, including the flow of exhaust gas 24 through the EGR valve 85 to be mixed with fresh air 72 to form the compressed intake charge 20. As a result, the compressed intake charge 20 may comprise a continuously variable combination of fresh air 72 and EGR 81, depending on the commanded quantity of EGR by the controller 60. As used herein, the term controller refers to an application specific integrated circuit (ASIC), an electronic circuit, a processor (shared, dedicated or group) and memory that executes one or more software or firmware programs, a combinational logic circuit, and/or other suitable components that provide the described functionality.

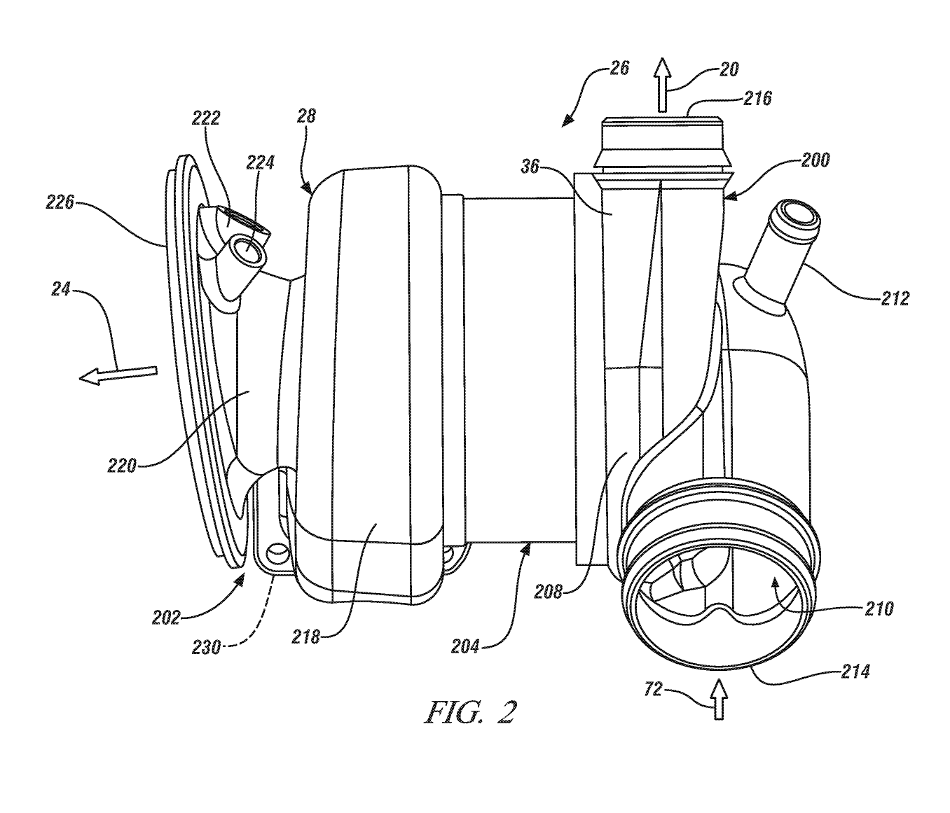

With continuing reference to the exemplary embodiment of FIG. 1, the compressor inlet 38 is integrated into compressor housing 36. The fresh air 72 flows through air supply conduit 41 toward a volute in the compressor housing 36, wherein the compressor wheel 35 compresses the air. By integrating the compressor inlet 38 and the compressor housing 36 as a single component, the flow path of fresh air 72 is controlled to provide improved and increased air flow into the compressor housing 36. An exemplary compressor inlet 38 provides a tangential component to the flow of fresh air 72, thereby causing a swirling effect as the air flows into the compressor housing 36. In embodiments, the swirling of fresh air 72 is induced by an offset portion of the compressor inlet 38. The fresh air 72 is configured to swirl in the same rotational direction of compressor wheel 35, thereby increasing the volume of air inducted and improving the efficiency of the turbocharger 26. Further, integration of the turbine outlet 220 (FIG. 2) and turbine housing 28 improves control over flow of the exhaust gas 24 into the catalytic converter 50. Improved control over flow improves the distribution and uniformity of the exhaust gas 24 as it flows into a substrate of the catalytic converter 50, thereby improving performance of the exhaust treatment system. The integrated turbine outlet 220 and turbine housing 28 also reduce the number of parts in the turbocharger 26, thereby reducing cost and simplifying the manufacture of the turbocharger 26. Exemplary embodiments of the turbocharger 26 as well as various arrangements thereof are described in detail below with reference to FIGS. 2-4.

FIG. 2 is a side view of an exemplary turbocharger 26 which includes a compressor portion 200, a turbine portion 202 and a shaft housing 204. The compressor portion 200 includes the compressor housing 36, a compressor volute 208 and a compressor inlet 210. The compressor volute 208 houses compressor wheel 35 (FIG. 1) and receives fresh air 72 via the compressor inlet 210 (also referred to as “compressor inlet passage” or as “compressor inlet duct”). A PCV valve housing 212 may be integrated into the compressor inlet 210 to receive a PCV valve. The fresh air 72 is directed through an inlet opening 214, wherein the compressor volute 208 receives the fresh air 72 and the compressor wheel 35 compresses the air to form the compressed intake charge 20, which is directed to the intake manifold 18 (FIG. 1) by a compressor housing outlet 216. The turbine portion 202 includes the turbine housing 28, a turbine volute 218, a turbine outlet 220 and optional sensor housings 222 and 224. The turbine outlet 220 (also referred to as “turbine outlet passage” or as “turbine outlet duct”) is integrated into the turbine housing 28 and includes a turbine outlet opening 226 configured to direct exhaust 24 to an exhaust treatment system, such as the catalytic converter 50. The exhaust 24 is received through a turbine inlet 230 and is directed to the turbine wheel 27 (FIG. 1) within the turbine volute 218. The flow of exhaust 24 through the turbine housing 28, including turbine volute 218, drives rotation of the turbine wheel 27 and, accordingly, the compressor wheel 35, thus providing the compressed intake charge 20 for the internal combustion engine 10 (FIG. 1).

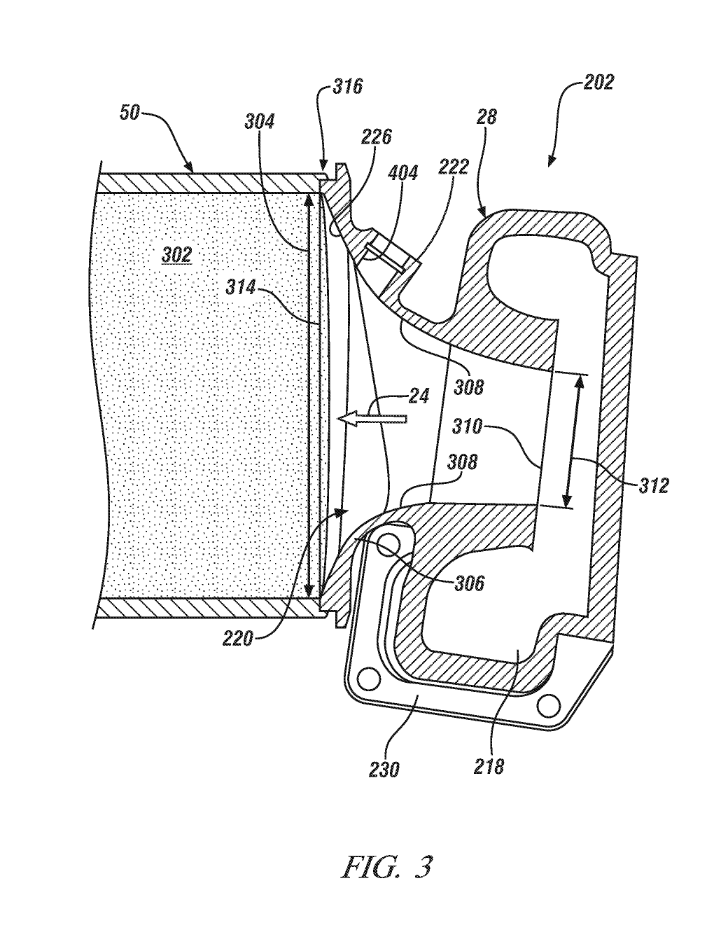

FIG. 3 is a sectional side view of the exemplary turbine portion 202 including the turbine outlet 220 (also referred to as “turbine outlet passage”) integrated into the turbine housing 28. The turbine outlet 220 is closely coupled to catalytic converter 50 which houses a substrate 302 configured to reduce pollutants from the exhaust gas 24. As depicted, a diameter 304 of an opening in the turbine outlet 220 is substantially equal to a diameter of the substrate 302. The exemplary turbine outlet 220 comprises a cone shaped passage 306, wherein the cone shape includes an arc shaped (in the shape of an arc or arced) or tapered opening that gradually expands in a direction of the exhaust 24 flow. Accordingly, a cross section of an inner surface 308 of the cone shaped passage 306 comprises an arc or is arc shaped. Further, the cone shaped passage 306 comprises an outlet opening 310 from the volute 218 wherein a diameter 312 of the cone shaped passage 306 gradually increases or expands along the arc shaped inner surface 308 in the direction of exhaust flow 24.

The geometry of the cone shaped passage 306 enables control over the flow of exhaust gas 24, thereby enabling improved distribution of the exhaust gas 24 across a face 314 of the substrate 302. As exhaust gas 24 is evenly distributed across the face 314 of the substrate 302, it improves performance of the exhaust after treatment system. The disclosed invention improves pollutant reduction as well as flow into and through the substrate 302, reducing exhaust back pressure experienced by the engine 10. The exemplary turbine outlet 220 is coupled directly to the catalytic converter 300, thereby positioning the substrate 302 proximate the turbine outlet opening 226. Thus, the turbine outlet 220 controls, and uniformly distributes, the exhaust 24 flow due to a direct coupling 316 (or “close coupling”) to the catalytic converter 300. The coupling 316 may be any suitable durable mechanism that can withstand high temperatures, such as a band, weld or braze configured to join the turbine outlet 220 and catalytic converter 300. In an embodiment, the distribution of exhaust 24 is described by a uniformity index. An exemplary turbine outlet 220 has a uniformity index greater than about 0.7 and the index is about 7% higher as compared to other turbine outlet configurations. In another example, a uniformity index is greater than about 0.9 at a selected operating condition for the emission cycle. The exemplary operation conditions include 1200-1600 RPM, such as 1400 RPM, at 4 bar mean effective pressure (load on the piston). Flow uniformity index may be generally described as a calculated value that indicates the relative amount of flow velocity variation on a defined plane in a flow path. An equation used to calculate uniformity index is:

$$UI = 1 - \frac{1}{2} \frac{\int \vert u - \tilde{u} \vert d A}{\tilde{u} \int d A} ; where$$

$$\tilde{u} = \frac{\int u d A}{\int d A} ;$$

A=flow area being analyzed; dA=individual portions of the area where velocity can be measured in each portion; and u=velocity magnitude.

In an embodiment, improved distribution of the exhaust 24 into the catalytic converter 50 improves flow from the turbine volute 218. The improved flow from the turbine volute 218 improves the removal of exhaust from the housing 28 to reduce resistance on the rotating turbine wheel 27 as it is driven by incoming exhaust flow. Thus, the exemplary turbocharger 26 and the turbine housing 28 improve exhaust system 14 performance. In addition, the exemplary turbine outlet 220 comprises a substantially asymmetrical geometry to provide direct coupling to the catalytic converter 50.

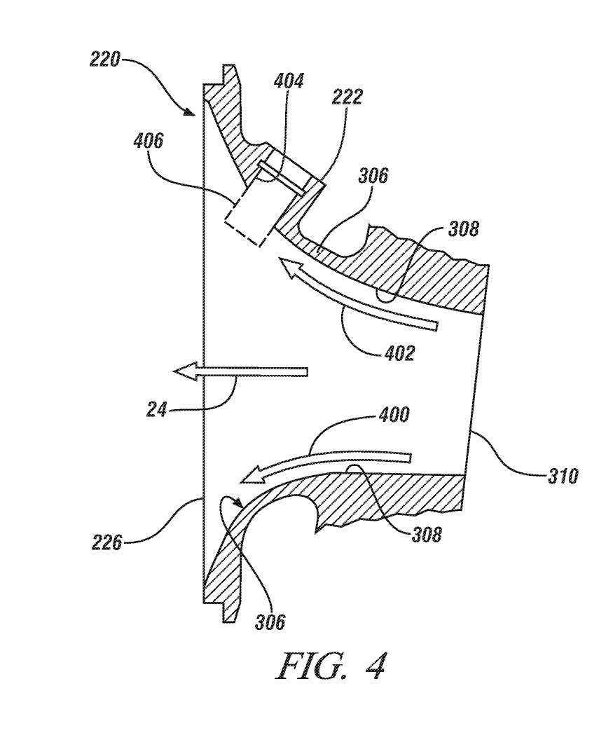

FIG. 4 is a detailed side view of a portion of the exemplary turbine outlet 220 of FIG. 3. As depicted, the cone shaped passage 306 is configured to direct components of the exhaust flow 24, depicted as 400 and 402, along inner surface 308 to improve distribution of exhaust gas 24 at the turbine outlet opening 226. The exemplary turbine outlet 220 may include a sensor housing 222 configured to receive a sensor in a cavity 404. The sensor is configured to protrude from the cavity 404 as shown by a line 406, wherein the protruding sensor is in the path of exhaust flow 24, 402. By placing the sensor in the exhaust flow 24, 402 path, the accuracy of the sensor measurement is improved. Exemplary sensors may be configured to determine various exhaust parameters, including, but not limited to, temperature, NOx content, oxygen content or amounts of other constituencies in the exhaust gas. Thus, the disclosed arrangement of turbine outlet 220 and housing 28 improves measurement of conditions in the turbocharger 26.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed but that the invention will include all embodiments falling within the scope of the present application.

What is claimed is:

1. A turbine housing for a forced induction system of an internal combustion engine, the turbine housing comprising:
a turbine inlet passage in fluid communication with a turbine volute configured to house a turbine wheel, the turbine inlet passage configured to direct an exhaust gas flow from an exhaust manifold to the turbine wheel; and
a turbine outlet passage in fluid communication with the turbine volute, the turbine outlet passage configured to direct the exhaust gas flow to a catalytic converter coupled to the turbine outlet passage, wherein the turbine outlet passage comprises a cone shaped passage.

2. The turbine housing of claim 1, wherein the cone shaped passage is configured to distribute the exhaust gas flow across a substrate face of the catalytic converter.

3. The turbine housing of claim 1, wherein the cone shaped passage directs a portion of the exhaust gas flow along an inner surface of the cone shaped passage.

4. The turbine housing of claim 1, wherein an inner surface of the cone shaped passage comprises a flow area that increases in a direction of the exhaust gas flow.

5. The turbine housing of claim 1, wherein an inner surface of the cone shaped passage comprises a substantially arc shaped cross section.

6. The turbine housing of claim 1, wherein an opening of the turbine outlet is coupled to the catalytic converter via a coupling.

7. The turbine housing of claim 6, wherein the coupling comprises a weld or a band.

8. The turbine housing of claim 1, wherein the turbine outlet passage has a flow uniformity value into the catalytic converter of greater than about 0.9 at a selected operating condition.

9. The turbine housing of claim 1, wherein the turbine outlet passage comprises a substantially asymmetrical passage.

10. The turbine housing of claim 1, wherein the turbine housing comprises a sensor housing configured to position a sensor substantially in a flow path along an inner surface of the turbine outlet passage.

11. A turbocharger for an internal combustion engine, the turbocharger comprising:
a turbine housing configured to receive an exhaust flow from an exhaust manifold; and
a turbine outlet passage integrated in the turbine housing, the turbine outlet being a substantially asymmetrical passage in fluid communication with a turbine volute, the turbine outlet passage configured to be coupled to a catalytic converter and to direct the exhaust gas flow from the turbine volute to a catalytic converter substrate.

12. The turbocharger of claim 11, wherein the turbine outlet passage comprises a cone shaped passage.

13. The turbocharger of claim 12, wherein the cone shaped passage directs a portion of the exhaust gas flow along an inner surface of the cone shaped passage.

14. The turbocharger of claim 11, wherein an inner surface of the turbine outlet passage comprises a substantially arc shaped cross section.

15. The turbocharger of claim 11, wherein an opening of the turbine outlet is coupled to the catalytic converter via a coupling.

16. The turbocharger of claim 15, wherein the coupling comprises a weld or a band.

17. The turbocharger of claim 11, wherein the turbine outlet passage comprises a cone shaped passage configured to distribute the exhaust gas flow across a face of the substrate to cause a flow uniformity value of greater than about 0.9.

18. The turbocharger of claim 11, wherein the turbine housing comprises a sensor housing configured to position a sensor substantially in a flow path along an inner surface of the turbine outlet passage.

19. A method for directing exhaust in a forced induction system of an internal combustion engine, the method comprising:
directing an exhaust gas flow from an exhaust manifold via a turbine inlet passage to a turbine volute configured to house a turbine wheel; and
directing the exhaust gas flow from the turbine volute to a turbine outlet passage, wherein the turbine outlet passage comprises a cone shaped substantially asymmetrical passage; and
directing the exhaust gas flow from the turbine outlet passage to a catalytic converter coupled to the turbine outlet passage.

20. The method of claim 19, wherein directing the exhaust gas flow from the turbine outlet passage comprises distributing the exhaust gas flow across a face of a catalytic converter substrate to cause a flow uniformity value of greater than about 0.9 at a selected operating condition.
